(19) United States
(12) Patent Application Publication
(10) Pub. No.: US 2025/0341220 A1
(43) Pub. Date: Nov. 6, 2025

(54) CEILING FAN WITH ADJUSTABLE BLADES

(71) Applicant: CORDELIA LIGHTING, INC., RANCHO DOMINGUEZ, CA (US)

(72) Inventor: JAMES KENG, RANCHO DOMINGUEZ, CA (US)

(73) Assignee: CORDELIA LIGHTING, INC., RANCHO DOMINGUEZ, CA (US)

(21) Appl. No.: 19/266,131

(22) Filed: Jul. 10, 2025

Related U.S. Application Data
(63) Continuation-in-part of application No. 17/976,846, filed on Oct. 30, 2022, now abandoned.
(60) Provisional application No. 63/317,963, filed on Mar. 9, 2022.
(60) Provisional application No. 63/321,657, filed on Mar. 18, 2022.

(51) Int. Cl. F04D 29/36; F04D 25/06; F04D 25/08; F04D 29/32; F21V 33/00; F21Y 115/10

(52) U.S. Cl. CPC F04D 29/36; F04D 25/06; F04D 25/088; F04D 29/324; F04D 29/325; F21V 33/0096; F05D 2230/51; F05D 2240/303; F05D 2270/02; F05D 2270/807; F21Y 2115/10

(57) ABSTRACT

An electric ceiling fan and ceiling fan kit having adjustable fan blade sweep. The fan and kit include blade irons each with an arm having various mounting holes drilled at different distances from the hub. When the fan blades are attached to specific holes on the blade iron, the sweep of the fan blades is adjusted and set. Different length fan blades and/or blade irons may be used to adjust the fan blade sweep diameter. The motor controller accepts fan blade sweep parameter and motor RPM signals from two separate selector switches.

### CROSS-REFERENCE TO RELATED APPLICATIONS

This is a Continuation-In-Part (CIP) application of co-pending application Ser. No. 17/976,846, filed Oct. 30, 2022, which claims priority from provisional application No. 63/317,963, filed Mar. 9, 2022, and from provisional application No. 63/321,657, filed Mar. 18, 2022, the contents of all of which are hereby incorporated by reference.

### FIELD OF THE INVENTION

The present invention relates to electric ceiling fans. More precisely, the present invention relates to an electric ceiling fan and kit having user adjustable fan blades for sweep and pitch.

### BACKGROUND

A conventional construction of an electrical ceiling fan has an electric motor mounted at the center axis of the fan with blades that extend radially outward from the center. The conventional ceiling fan is mounted to an electrical junction box attached to a ceiling joist. The junction box includes a mounting bracket that receives a canopy and a down rod therein. The down rod passes through the canopy and into the motor housing containing the electric motor. A plurality of mounting arm brackets are attached to the motor's rotating center shaft as with spokes on a hub of a wagon wheel. Each mounting arm bracket has permanently affixed to it a radially extending fan blade. Just beneath the rotating blades is an optional light fixture enclosing an illumination source such as a bulb or LED. The hot-neutral-ground connections inside the junction box consist of the wiring fed through the hollow core of the down rod to power the electric motor. The junction box is wired to a common AC power source.

Conventional ceiling fans are sold with a fixed fan blade outside diameter or sweep, and their blades are permanently attached to the mounting arm bracket. The consumer typically purchases the fan size, blade sweep, and volume of air movement desired based on the requirements of his or her room size. As a result, retailers must maintain a large variety of fan sizes with varying fan blade sweeps in inventory to cater to the varying demands of the consumer. This is not efficient use of a retailer's shelf space or its capital investment in potentially unsold inventory of unpopular fan sizes.

### SUMMARY OF THE INVENTION

The present invention in a preferred embodiment is directed to an electric ceiling fan and kit that includes a user-or installer-adjustable fan blade sweep diameter, and optionally, a fan blade pitch adjustment. Thus, one fan kit can accommodate many consumers' varied demands for a fan sweep personalized to their own unique room size and preferred air movement volume (CFM or Cubic Feet per Minute) for that room size.

The preferred embodiment fan and kit include a down rod passing through a canopy, a motor that is disposed proximate the canopy and engages the down rod, wherein the motor includes a hub. A plurality of fan blades each having a fixed, non-telescoping length with a flat profile and includes a proximal end and a distal end. The fan has a plurality of blade irons each having a first end and second end, wherein the blade iron is attached to the motor hub at the first proximal end, and the second distal end includes an arm engaging the proximal end of the blade that can be manually adjusted for the blade's desired sweep an/or pitch.

The blade iron arm includes any one or combination of the following features: (a) an arm length with different attachment points along the length connected to the proximal end of the blade; (b) a telescoping length connected to the proximal end of the blade; (c) at least two discrete segments joined to each other with different attachment points connected to the proximal end of the blade; (d) arms of different lengths each connectable to the proximal end of the blade; (e) jaws that clamp the proximal end of the blade; and (f) discrete segments stackable together and connected to the proximal end of the blade; and (g) angular attachment points connected to the proximal end of the blade to set a pitch of thereof. The fan kit may be further supplied with different length blades so the end user or installer can select the desired blade length and manually attach each to the respective blade iron arm. The fan has a power supply conducting electricity to the motor. Optionally, the fan may include a light fixture with, e.g., LEDs, to also operate as an illumination source.

In another alternative embodiment ceiling fan, a blade support shell at least partially covering the rotating hub has a plurality of slots to receive the proximal end of each fan blade. There is an internal blade bracket that has rows of attachment points disposed at radial locations that attach the proximal end of each fan blade for a selected blade sweep. The internal blade bracket engages the rotating hub and is enclosed within the blade support shell. An electronic motor controller receives load parameters to adjust the motor output to compensate for at least rotational inertia and air resistance caused by the selected blade sweep. A selectable switch manipulated by the user inputs the motor load parameters to the controller. The load parameter switch is additional to a fan blade speed/RPM switch or pushbutton, and does not affect fan blade speed/RPM. There may also be external blade brackets with more attachment points for further extending the blade sweep to even larger diameters.

### BRIEF DESCRIPTION OF THE DRAWINGS

FIG. 1 is a perspective view of a preferred embodiment ceiling fan with the blades set at an extended radial length for maximum sweep.

FIG. 2 is another perspective view of the ceiling fan of FIG. 1.

FIG. 3 is another perspective view of the ceiling fan of FIG. 1.

FIG. 4 is another perspective view of the ceiling fan of FIG. 1.

FIG. 5 is another perspective view of the ceiling fan of FIG. 1.

FIG. 6 is a perspective view of the ceiling fan from FIG. 1 with the blades set at a short radial length for minimum sweep.

FIG. 7 is another perspective view of the ceiling fan of FIG. 6.

FIG. 8 is another perspective view of the ceiling fan of FIG. 6.

FIG. 9 is another perspective view of the ceiling fan of FIG. 6.

FIG. 10 is an illustration of the major components of an electric ceiling fan.

FIG. 11 is a schematic depicting the blade sweep of a ceiling fan.

FIG. 12 shows an exemplary embodiment ceiling fan blade.

FIG. 13 shows the reverse side of the ceiling fan blade of FIG. 12.

FIG. 14 shows an exemplary embodiment blade iron.

FIG. 15 shows the reverse side of the blade iron of FIG. 14.

FIG. 16 shows a preferred embodiment down rod.

FIG. 17 shows miscellaneous components and fasteners that assemble to the blade irons.

FIG. 18 is an electric motor.

FIG. 19 is a cover disposed on top of the motor.

FIG. 20 is a lens cover for the light fixture.

FIG. 21 is a light fixture located at the bottom of the ceiling fan.

FIG. 22 shows a preferred embodiment electric ceiling fan kit.

FIG. 23A shows a set of long fan blades and FIG. 23B shows a set of short fan blades, both sets optionally supplied in the kit.

FIG. 24 shows an alternative embodiment blade iron that can be separated into sections.

FIG. 25 shows a preferred embodiment blade iron with a blade pitch adjustment.

FIG. 26 shows an alternative embodiment blade iron.

FIG. 27 shows another alternative embodiment blade iron.

FIG. 28 shows yet another alternative embodiment blade iron.

FIG. 29 shows a motor hub with pitch adjustable collars to receive blade irons.

FIG. 30 shows an alternative embodiment blade iron that is threaded and stackable.

FIG. 31a and FIG. 31b show handheld wireless remotes that include switches to adjust motor output to compensate for inertia and air resistance encountered when changing fan blade sweep, and that are in addition to fan blade speed or RPM controls.

FIG. 32 is a side elevational view of an alternative embodiment ceiling fan with hidden fan sweep adjustment hardware.

FIG. 33 is a top view of the internal hardware for fan blade sweep adjustment.

FIG. 34 is a bottom view of the internal blade bracket.

FIG. 35 is a bottom view of the internal blade bracket with fan blades attached.

FIG. 36 is a bottom view of the internal blade bracket with fan blades attached to a different row of attachment points to change the fan blade sweep.

FIG. 37 is a bottom view of an external blade bracket.

FIG. 38 is a top view of an external blade bracket.

FIG. 39 shows the top and bottom halves of the external blade bracket being assembled together.

FIG. 40 is another view of the top and bottom halves of the external blade bracket assembled together.

FIG. 41 shows the top and bottom halves of the external blade bracket halves sandwiching the fan blade therebetween.

FIG. 42 shows two blade sweep diameters achievable with internal blade brackets.

FIG. 43 is a top view of a ceiling fan showing three additional blade sweep diameters achievable with external blade brackets.

FIG. 44 is a bottom view of the ceiling fan from FIG. 43.

FIGS. 45a-45e show a preferred embodiment ceiling fan with user selectable blade sweep diameters of 44 inches, 48 inches, 52 inches, 56 inches, and 60 inches.

### DETAILED DESCRIPTION OF THE PREFERRED EMBODIMENTS

The present invention is directed to an electric ceiling fan and kit where the fan blades may be adjusted by the end user or installer at the installation site. In a preferred embodiment, one blade adjustment contemplates the consumer extending/shortening the length of each blade by use of different blade irons or physical changes made to the blade iron to change the fan blade sweep diameter. This is accomplished at home by the consumer to tailor fit the blade sweep to the square footage of the room, whether for a small bedroom or a large living room, for example.

FIGS. 7-11 depict a preferred embodiment electric ceiling fan 5 having an electric motor 14 mounted at the center of the fan with a plurality of blades 10 that extend radially outward from the rotating center hub 32 of the motor 14. The ceiling fan 5 is suspended from a ceiling via a down rod 18 passing through a canopy 16. The canopy 16 covers a mounting bracket 20 attached to the junction box or ceiling fan box 28. At the distal end of the down rod 18 is a hanger ball 24 that suspends the weight of the ceiling fan 5 from inside the mounting bracket 20. The ceiling fan box 28 is preferably screwed or bolted into a ceiling joist. House wires 30 pass from the fan box 28 through the hollow down rod 18 to power the motor 14. At the bottom of the ceiling fan 5 is an optional light fixture 26 to illuminate the room below.

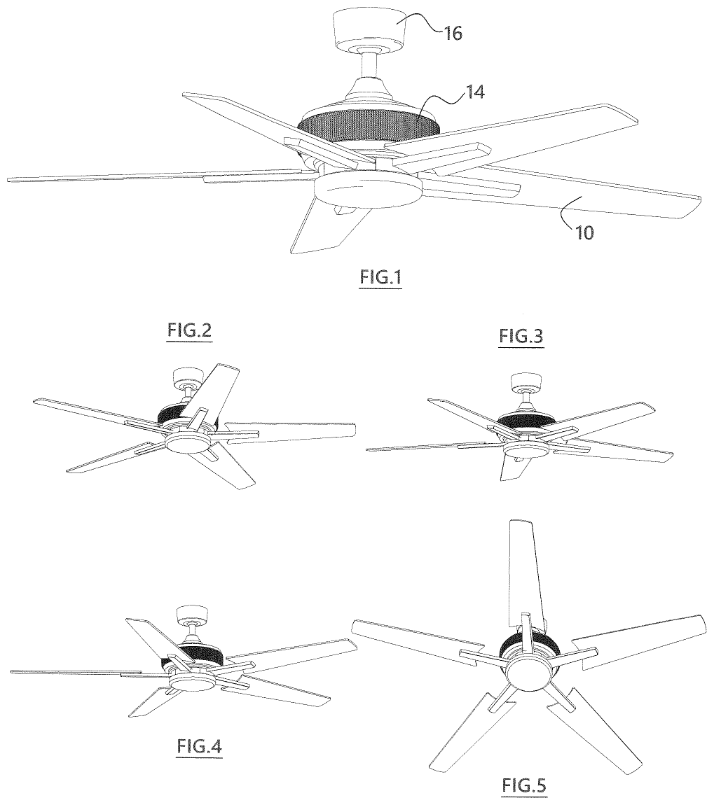

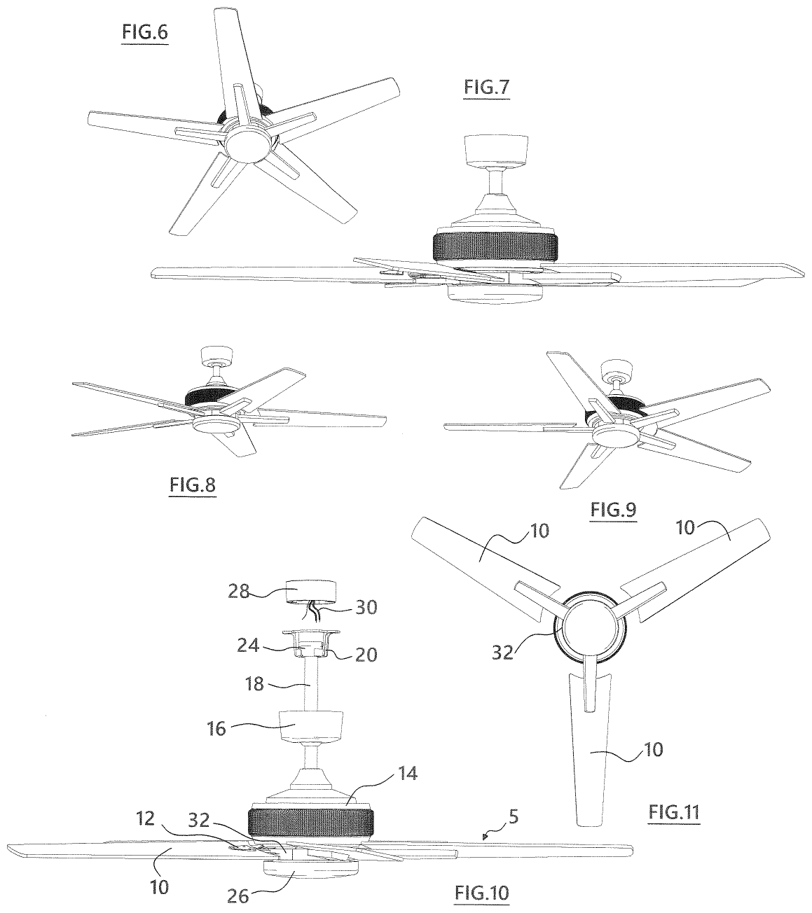

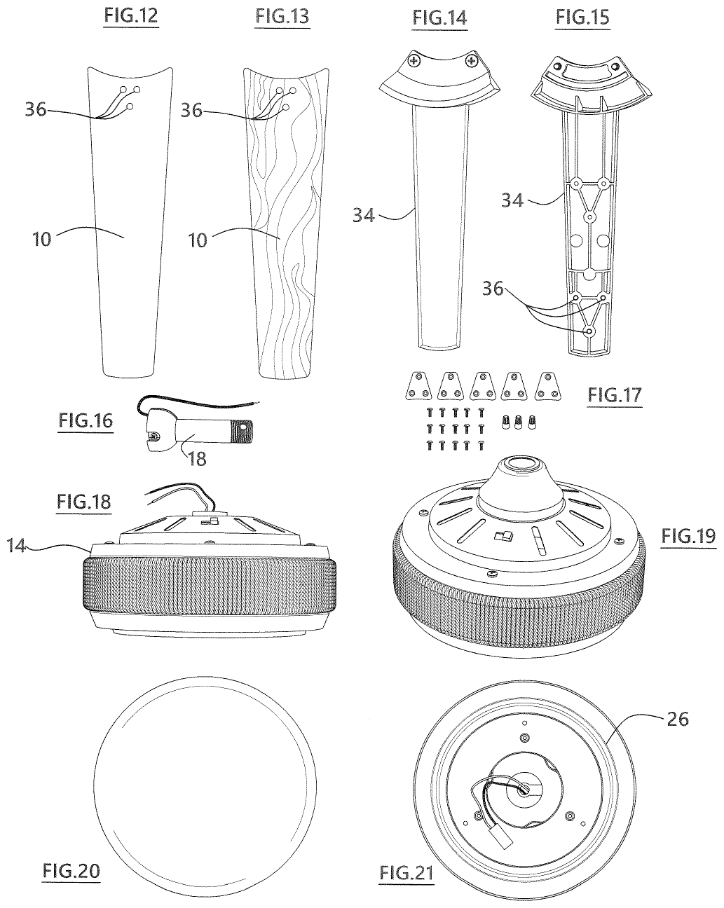

FIG. 11 depicts three blades 10 extending from the motor hub 32 of a ceiling fan. The blade sweep is defined as the diameter of a hypothetical circle delineated by the distal tips of the spinning fan blades. FIGS. 1-5 shows a preferred embodiment ceiling fan with a larger blade sweep diameter. In contrast, FIG. 6 shows the same ceiling fan as in FIGS. 1-5, but with the blade sweep adjusted to a smaller diameter. In this embodiment, the same fan blades are attached to the blade iron arms at different locations thereon to be either farther away from the center hub (larger sweep diameter, FIGS. 1-5, 7-11) or closer to the center hub (smaller sweep diameter, FIG. 6). In alternative embodiments, there may be more than two-hole mounting locations along the blade iron to give the user even more choices for setting blade sweep diameter.

Another blade adjustment mechanism contemplates setting the pitch angle (as with a propeller in an airplane) of the fan blade by use of different blade irons or making physical changes to the blade irons as discussed in detail below. One or both adjustments enable the user to precisely control the volume, speed, and momentum of the air flow being pushed through the fan blades. Thus, a single fan kit purchased by the end user can be installed to cool a variety of room sizes from small to large merely by setting the proper blade sweep and/or pitch angle.

To achieve the sweep adjustments for the fan blades demonstrated in FIGS. 1-11, a preferred embodiment of the present invention is provided with unique fan blades and complementary blade iron mounting arms/blade irons. More precisely, FIGS. 12, 13 show the front and reverse sides of a preferred embodiment fan blade 10. FIGS. 14, 15 show the front and reverse sides of a preferred embodiment blade mounting arm/blade iron 34. At the proximal end of the blades 10 are mounting holes 36 (FIGS. 12, 13), and the blade irons 34 have preferably two sets of three mounting holes 36, with one set located closer to the hub and another set located farther away (FIG. 15). In alternative embodiments, there may be more than or fewer than two mounting hole locations in the blade iron.

Which sets of holes 36 in the blade iron 34 (FIG. 17) selected and used to attach the fan blade 10 sets the blade sweep diameter. Each fan blade 10 is attached to its respective blade iron 34 by aligning the respective mounting holes 36, then passing a fastener or pin and locking the two parts together with mounting brackets and hardware shown in FIG. 17. The multiple locations of the mounting holes 36 are preferably created in the blade irons 36 instead of the fan blade 10, because too much drilling and missing material weakens the already thin and lightweight blades, whereas the blade irons are usually made of metal and have sufficient strength to accommodate multiple mounting holes drilled therein. However, it is still contemplated to form multiple locations for the mounting hole in a fan blade to adjust its sweep.

The preferred embodiment trapezoidal-shaped hardware shown in FIG. 17 that assemble to the blade iron 34 of FIG. 15 are screwed or bolted together using fasteners. Or the parts may clamp together where the trapezoidal-shaped hardware acts as a jaw to clamp onto the proximal end of the fan blade. All of the blade mounting hardware are removable to enable disassembly of the fan blade 10 from the blade iron 34. This allows the user to change the mounting hole attachment location 36 on the blade iron 34 if the blade sweep diameter is determined after installation to be too small or too large, i.e., from the configuration in FIGS. 1-5 to the configuration in FIG. 6 or vice versa.

Each preferred embodiment fan blade is made from molded or extruded plastic, but aluminum, wood, epoxy, fiberglass or like materials are contemplated. The preferred fan blades are unitary or one solid piece, do not telescope, and have a solid core for rigidity. The blades may further have a low or flat profile (as seen in FIG. 7 or 10), but a curved or airfoil, propeller, and the like profiles are also contemplated. In the preferred embodiment, each of the plurality of fan blades includes a leading edge that has a thickness that is less than 10% of a chord of the blade. Also, each of the plurality of fan blades includes an aspect ratio of a leading-edge thickness to a chord of the blade that is, preferably, greater than 1:10. This leads to quiet operation (reduced wind and motor noise) as well as improved aesthetics appropriate for residential, restaurant, hotel applications and the like where an environment's overall pleasing appearance is important.

The thin-profile cross-section blades are distinct from High Volume Low Speed (HVLS) industrial fans that are usually hollow, have a boxy-shaped cross-section and are typically used in a factory or warehouse setting where loud noise is not a concern.

Optionally, as better suited for residential use, the obverse and reverse sides (FIGS. 12, 13) may have different finishes or colors which the end user can choose for the visible side facing the room below. These aspects of the blade construction and base material ensure the manufacturing costs are under low, because multiple sets of different length blades may be supplied in a single kit from which the end user may choose the desired length.

FIG. 16 shows a down rod having a tube shape with a hollow interior allowing electrical wires from the house power lines passing through it to the motor 14. FIG. 18 is an isolated view of the electric motor 14. FIG. 19 shows the decorative top cover for the motor assembly. FIG. 20 shows the light fixture lens or diffuser, and FIG. 21 shows the internals of the light fixture 26 covered by the lens or diffuser.

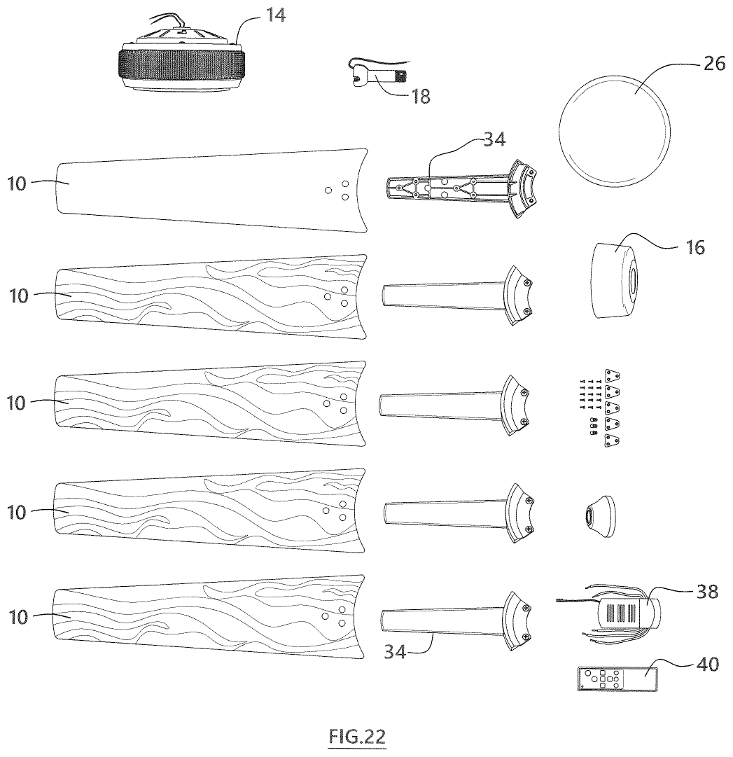

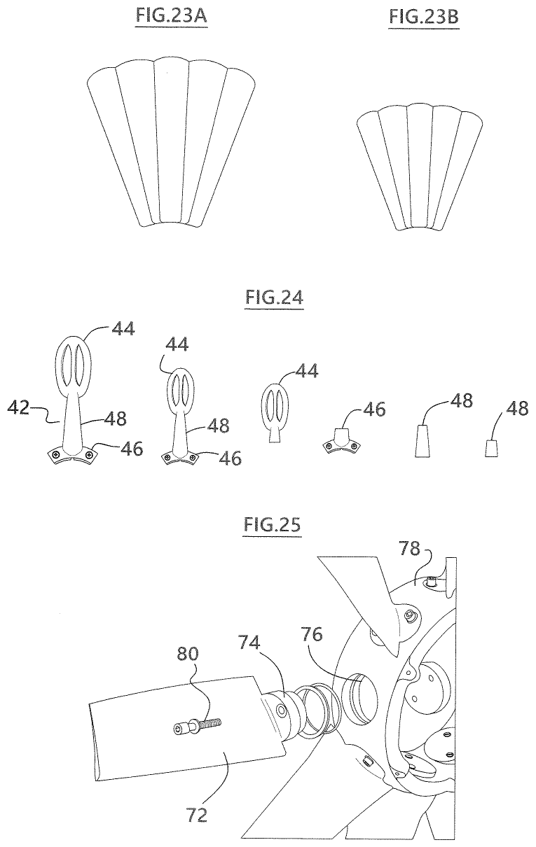

FIG. 22 shows the typical contents of a ceiling fan kit. In this kit, the motor, ceiling mount hardware, fan blade irons, fan blades, light fixture, fan remote controls, etc., are included. The blade sweep can be set when the present invention kit is supplied with different length blades as seen in FIGS. 23A, 23B, or different length blade irons as seen in FIG. 22. The kit components of FIG. 22 may include a Color Coordinated Temperature (CCT) module 38 used to electronically set the color of the LEDs emitting light from the light fixture 26. The components may also include a wireless remote control 40 for controlling fan functions, CCT temperature, motor forward or reverse, power on/off, etc. As seen in FIG. 22, the blades 10 may have different finishes, textures, or colors on either face.

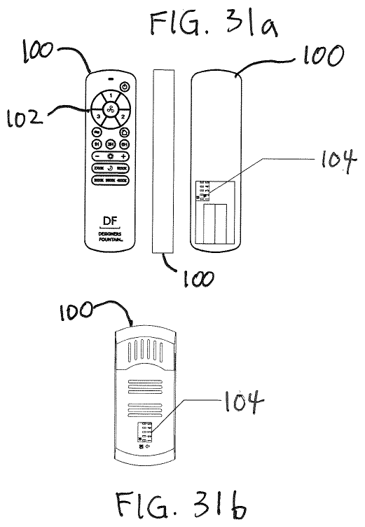

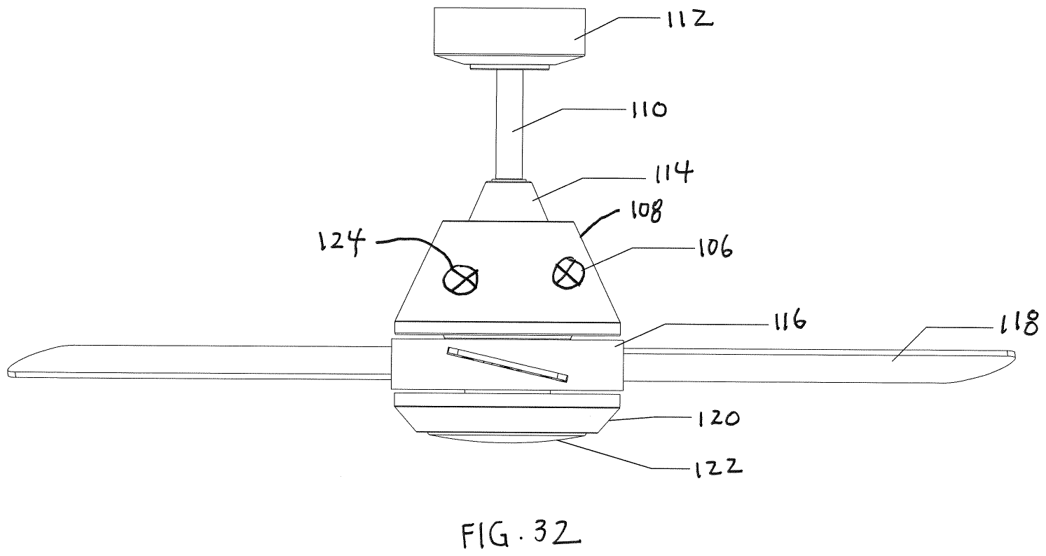

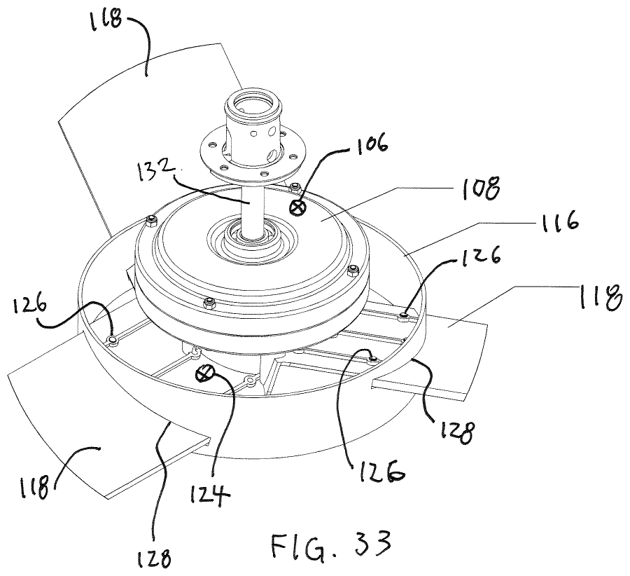

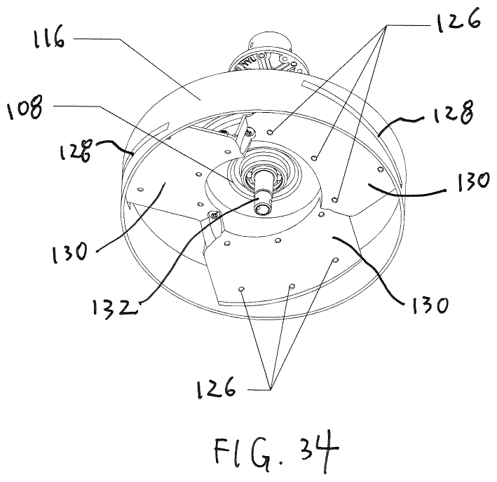

In addition to what was described above, the following drawing figures illustrate more of the contemplated means for adjusting the blade irons/fan blades to set the blade sweep diameter. FIG. 24 shows a blade iron 42 having a distal end 44 (attachable to the proximal end of a fan blade) and a proximal end 46 (attachable to the motor hub). In between the distal end 44 and the proximal end 46 are intermediate sections 48 that are stackable to increase or decrease the overall length of the blade iron 42. By use of more or fewer intermediate sections 48, the blade iron becomes longer or shorter, respectively. Thus, it is possible to adjust the sweep diameter of the blades to increase or decrease. The stackable intermediate sections 48 can be linked together by interference or press fit, mechanical hooks, interlocking joints, an interlocking roll pin, fasteners, adhesive, threaded complementary ends, snap fittings, internal threads, or the like. FIG. 30 shows intermediate sections 50, 52 that are threaded together to extend or shorten the length of a blade iron.

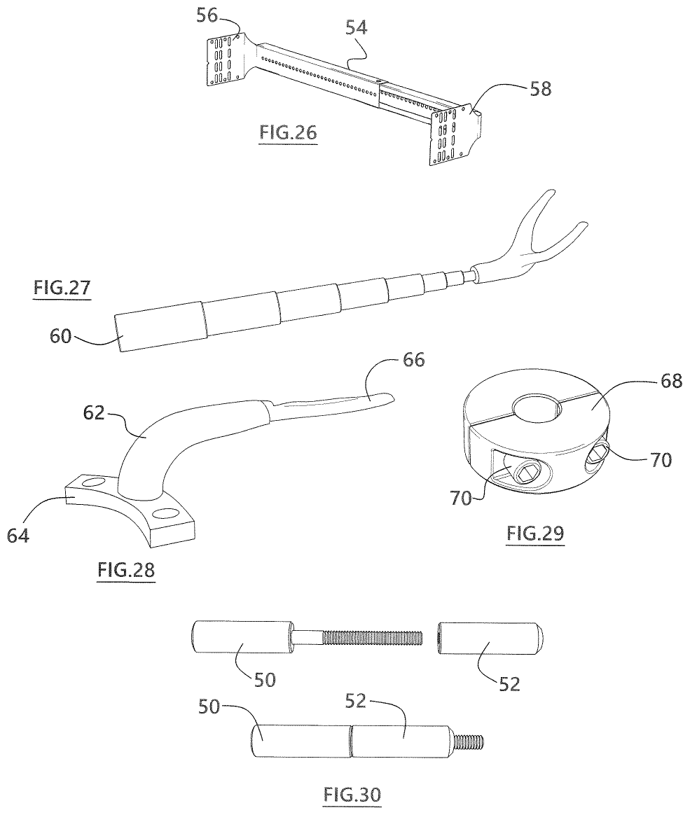

FIG. 26 is an alternative embodiment blade iron 54 using a sliding, telescoping bracket concept for adjusting its length. The blade iron 54 has a distal end 56 attachable to the fan blade and a proximal end 58 attachable to the motor hub with an extended length intermediate section therebetween. The rectangular cross-section of the blade iron allows one section to slide into the other section with a telescoping action. Once that length is set, a roll pin, a stop, a fastener, a catch, a biased hook, a detent, or the like, can be interposed between the two sections to immobilize any relative movement.

FIG. 27 shows an alternative embodiment blade iron 60 that is a single, round shaft that can be simply cut into a shorter overall length, or cut into two pieces by the fan installer, separating the proximal motor end from the distal fan blade end. One or more threaded inserts are then used to re-join the two pieces to form the desired end length for the blade iron.

A tubular shaped blade iron similar to FIGS. 26, 27 may be configured to have a telescoping feature where the intermediate sections retract into the next larger diameter section. The overall blade iron length may be set by retracting and extending the intermediate sections, then twisting on the internally-threaded sections to lock one section to the other.

FIG. 28 depicts yet another alternative embodiment for a blade iron 62 that is formed from a single shaft that can be cut into two pieces by the fan installer, separating the proximal, motor end 64 from the fan blade distal end 66. One or more threaded inserts are then used to re-join the two pieces to form desired lengths for the blade iron. In still another alternative embodiment, short pre-scored segments of the distal end may be broken off by hand into shorter sections. Of course, this would permanently decrease the length of the blade iron. The mounting holes for the distal end to attach the fan blade are repeated for each section that may be broken off.

FIGS. 25 and 29 depict an alternative embodiment blade adjustment means that adjusts the angular pitch of the fan blade. The pitch of the fan blade is the angle at which the blade is oriented relative to the plane defined by the blade's overall rotation around the hub. Thus, in FIG. 29, the fan hub 78 includes lockable collars 70 wherein the collar has a mounting hole 76 receiving the proximal end of a blade iron plug 74 and clamps or locks down on it via fastener 80. Accordingly, the pitch of the fan blade can be set based on the angle of the fan blade when it is locked in place.

In the embodiment of FIG. 25, the blade iron 72 has a plug insert 74 at its proximal end that is inserted into a receiving hole 76 in the motor hub 78. The hub 78 may have reference lines or hash marks to help the fan installer set the desired pitch angle for the blades. A set screw 80 may be threaded into the plug insert 74 to lock the blade iron 72 to the hub 78. Hash marks or markings may be provided on the hub to help guide the installer in setting the fan blade pitch.

In still another alternative for the means for adjusting the blade pitch, the FIG. 28 blade iron may be made from a softer, deformable metal such as aluminum or low carbon steel. Thus, once the length is set, the fan installer may twist and permanently deform the distal, fan blade end 66 of the blade iron relative to the proximal, motor hub end 64. The twisted deformation sets the angular pitch of the fan blade attached to the blade iron.

In the FIG. 27 embodiment, the telescoping blade iron 60 has a length set by twisting the threaded sections together. By that same mechanism, it is possible to twist the interlocking sections to set the angular pitch of the blade.

FIGS. 31-45 illustrate an alternative embodiment of an electric ceiling fan with user-adjustable blade sweep and with an electronic feedback loop that controls the motor's output based on the user-selected blade sweep. In this embodiment, the Do-It-Yourself (DIY) end user or installing electrician can adjust the fan blade length/sweep diameter for the target room, the air flow appropriate for the room's square footage (e.g., large living room versus tiny bedroom). The diameter of the fan blade sweep may be increased or decreased by extending or retracting the uniform length fan blades out of or into a blade support shell or fan housing, respectively.

At one extreme, extended fan blades with a large blade sweep encounter more rotational/dynamic inertia and encounter more air resistance due to more rotational mass and fan blade surface area being exposed to drive the surrounding air. A larger blade sweep implies more of the cantilever length of the fan blade is unsupported at the center hub. More surface area further creates more drag on the fan blades. These physical effects, known as motor load parameters, impart increased stress on the motor at any given motor RPM chosen by the user. Thus, the motor must be adjusted or fine-tuned to compensate for that increased load parameters arising from the greater fan blade sweep, usually by enabling a larger voltage/current draw for greater power. Without this motor adjustment to compensate for load parameters, the motor is overburdened and its duty life shortened, and the failure rate of the motor increases as seen from empirical testing. The motor may also overheat from that extra load, thereby being not being able to meet UL safety standards. However, if the end user or electrician presets the motor output in accordance with the selected blade sweep diameter, then the reliability and efficiency of the ceiling fan motor are improved significantly.

Conversely, if the blade sweep diameter is small and set by the user for a compact residential bedroom, for example, then the load on the fan motor will be much lighter due to the shorter fan blade length/sweep diameter with less cantilevered rotating mass. There will be lower rotational inertia, and less air resistance for a given motor RPM. In this small blade sweep configuration, the motor will be drawing more amperage than necessary. If the motor output is too high for the needed load, then electricity is wasted through heat generation, and a high current draw in the motor when it is not necessary reduces the life of the motor. Finally, a ceiling fan motor consuming high amperage when not needed to drive the shorter fan blades wastes energy, so the fan will not meet government regulatory Energy Star efficiency standards, which is measured by Cubic Feet of air Mass per watt of energy used (CFM/watt).

Therefore, the preferred embodiment of the present invention ceiling fan includes an electronic closed loop system for adjusting motor output to compensate for at least the expected rotational inertia and air resistance created by the user-selected fan blade sweep diameter. The closed loop system includes a switch for inputting load parameters to the motor controller so the user can match or fine-tune motor output to the user's chosen fan blade sweep diameter.

As seen in in FIGS. 31a and 31b, a selector switch 104 can be set by the user based on the expected load parameters (preset at the factory) for a given blade sweep diameter chosen by the user. This is performed at home by the consumer upon installation of the fan at the consumer's residence. The selector switch 104 is present in a wireless remote 100 used to control the ceiling fan operation. If the wireless remote 100 is used, the motor controller 106 includes an antenna to receive wireless transmissions from the remote 100. The selector switch 104 is preferably hidden under a cover inside the remote 104, because the switch setting is initially chosen by the user or install electrician to match the selected fan blade sweep, and is not needed again until the fan blade sweep is changed. The fan blade sweep adjustment selector switch 104 is preferably a multi-position slide switch, DIP switches as shown, a toggle switch, or a rotating knob with click-stops that land on each possible fan blade sweep diameter selected by the user. Physical markings or symbols on the selector switch 104 lets the user or install electrician know which detent or click-stop to choose for the chosen fan blade sweep diameter.

The blade sweep adjustment switch 104 may also be embedded on the ceiling fan and hard wired to motor's on-board electronic motor controller or microprocessor 106 as seen in FIG. 32, which controller 106 sets the motor's power output. The blade sweep adjustment switch 104, if mounted on the fan, is hidden by a cover plate, and is set by the user or install electrician when the fan is mounted to the ceiling. The load parameters data from the switch 104 are then transmitted to the motor controller 106 for the electronic closed loop.

As seen in FIGS. 31a and 31b, it is important to note that the blade sweep diameter selector switch 104 is different from and in addition to the fan speed/motor RPM selector switch 102. As on conventional fans, the fan speed/RPM switch 102 is used to adjust only the fan blade speed to change the volume and speed of air flow inside the room based on a user's current preference. On the other hand, adjusting the separate motor parameter input switch 104 does not affect the fan speed or RPM. Thus, once the fan speed/RPM is chosen by the user, adjusting the sweep diameter selector switch 104 does not change the fan speed/RPM.

To be sure, fan motor power is commonly increased/decreased by adjusting voltage to the motor to increase/decrease; the associated motor current draw is likewise increased/decreased. Thus, higher voltage results in higher fan speed/RPM. This is how conventional fan speed switches operate. But the present invention motor parameter input switch 102, while adjusting the voltage to the motor to match the selected blade sweep, does not affect fan speed/RPM. This is accomplished at the factory by calculating the load on the motor based on the user-selectable blade sweep, and precisely tuning the motor voltage appropriate for each selectable blade sweep, yet not overly increasing the voltage to affect fan speed. On the other hand, a conventional fan speed remote control cannot perform this function; all it can accomplish is to increase or decrease fan speed. The presence of the present invention motor parameter switch (in addition to the standard fan RPM switch or dial) thus fine tunes the motor voltage to ensure high efficiency in consumption of electrical power, less heat generation, and improved reliability and longevity of the motor.

As seen in FIG. 32, an optional sensor 124 can be embedded or mounted on the motor shaft, a blade bracket, or blade iron for detecting and feeding blade sweep force data back to the electronic motor controller 106. The sensor 124 in a preferred embodiment can be a strain gauge or the like that continuously feeds back the detected loads from the selected fan blade sweep diameter, the blade's rotational inertia, air resistance encountered, blade mass, current motor RPM selected by the user, and like telemetry. The load data are fed to a microprocessor in the controller 108 to determine the needed motor output adjustments, continuously and on-the-fly.

Conventional electric ceiling fans include fan blades of a factory-predetermined length/sweep diameter intended for a specific target room size defined by square feet (e.g., small bedroom to a large, formal dining room) and maximum airflow (by Cubic Feet per Minute or CFM). With the factory-selected fan blade length/sweep, the proper motor is chosen during engineering design to be appropriate for that particular blade length/sweep diameter, blade mass, rotational inertia, air resistance, at all user-selectable fan blade RPMs. Therefore, fan blade length/sweep and the related operating parameters are all predetermined and known by the factory, and they are not changeable by the end user without violating product warranty, impeding fan performance, and causing a malfunction. Accordingly, conventional electric ceiling fans do not need another set of control switches 104, in addition to fan blade speed/RPM control 102, as in the claimed invention that specifically tailors motor output to the fan blade length/sweep selected by the end user.

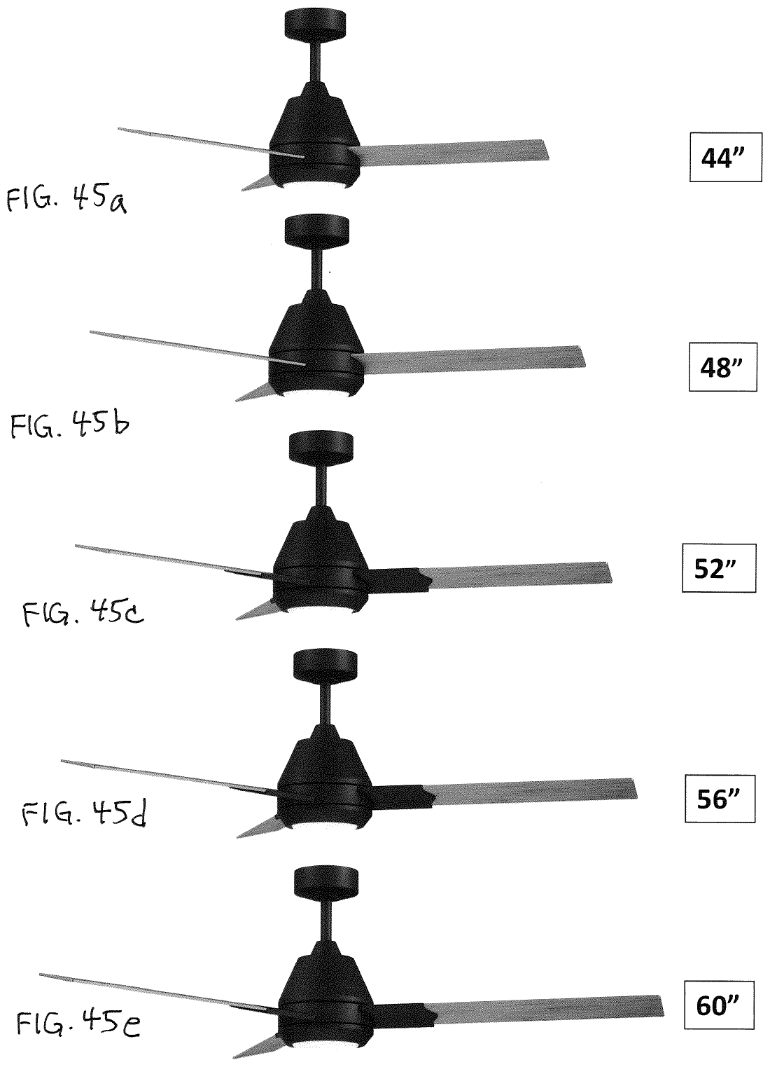

In accordance with a preferred embodiment, a single fan kit can be configured at home by the consumer to have a 44 inch, 48 inch, 52 inch, 56 inch, or 60 inch fan blade sweep, as illustrated in FIGS. 45a-45e. This is accomplished with a single set of fan blades, all of the same length, included in the kit. The user or install electrician simply configures the desired blade sweep by extending or retracting the fan blades when mounting the blades to the support shell or motor housing. For the selected fan blade sweep, the end user then makes the associated slide switch 104 selection to set the optimal motor output.

FIGS. 32-45 illustrate another feature of the preferred embodiment adjustable blade sweep ceiling fan where the fan blade sweep adjustment hardware is hidden within a housing or blade support shell 116. As seen in FIG. 32, the ceiling fan is suspended from a ceiling power receptacle 112 by a down rod 110 that leads to a canopy 114 and motor/motor housing 108. Beneath the motor 108 is the rotating blade support shell 116 and fan blades 118 driven by a rotating center hub 132. This exemplary embodiment also includes an optional, decorative bezel 120 surrounding an optional LED light 122.

FIGS. 33, 34, and 35 show an embodiment with hidden blade sweep mounting hardware. FIG. 33 is a top view of the fan with the motor housing or shroud removed to reveal the motor 108. The proximal ends of the fan blades 118 are inserted through receiving slots 128 formed in the blade support shell 116, wherein the blade support shell supports the proximal ends of the cantilevered fan blades 118. The proximal ends of the fan blades 118 include fastener attachment points 126. FIG. 33 also shows possible mounting positions of the motor controller 106 and the load sensor 124.

FIG. 34 is a bottom view of the fan with the fan blades 118 omitted. Inside the blade support shell 116 are three internal blade brackets 130 corresponding to the three fan blades 118 in this embodiment. These internal blade brackets 130 engage the center hub of the motor 132. Each blade bracket 130 has an array of attachment points or sites 126 arranged in rows that are intended to align with and engage the corresponding attachment points 126 on the fan blades 118 of FIG. 33. FIG. 34 shows two rows of attachment points 126 spaced apart at two different radii as measured from the center hub 132. These two different radii are the installation positions for the two user-selectable blade sweep diameters.

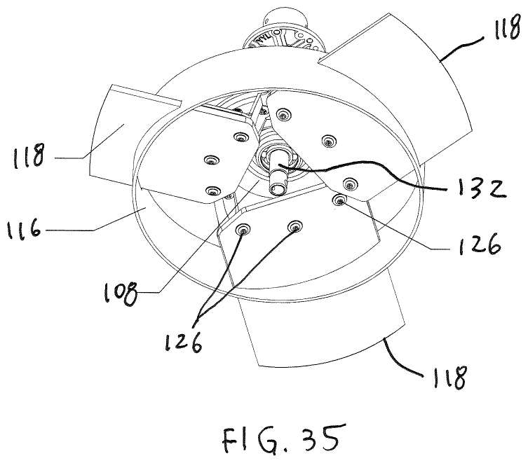

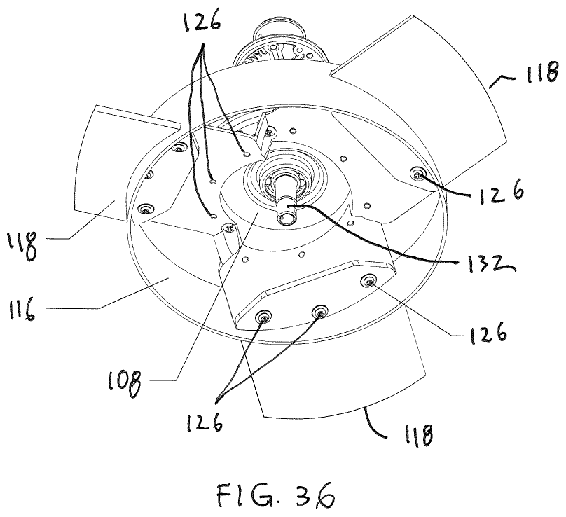

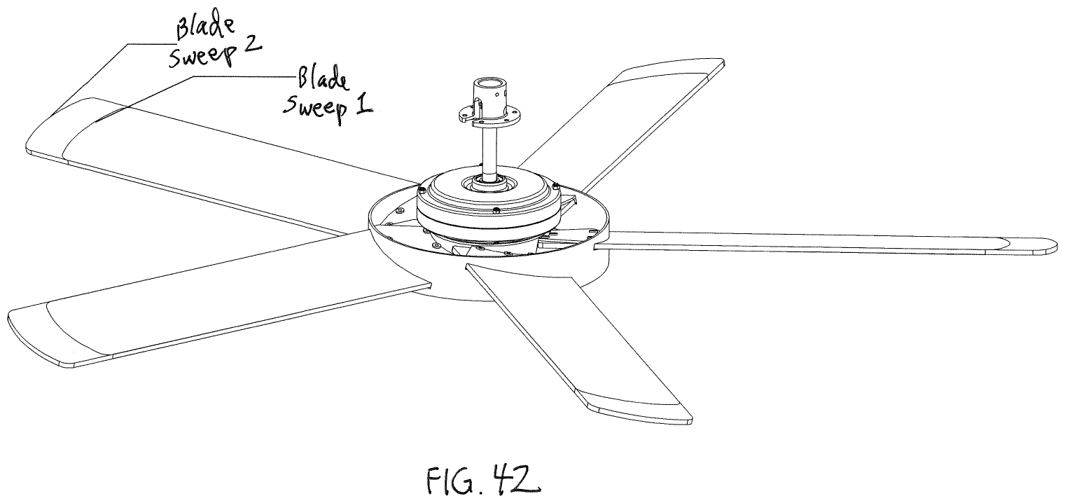

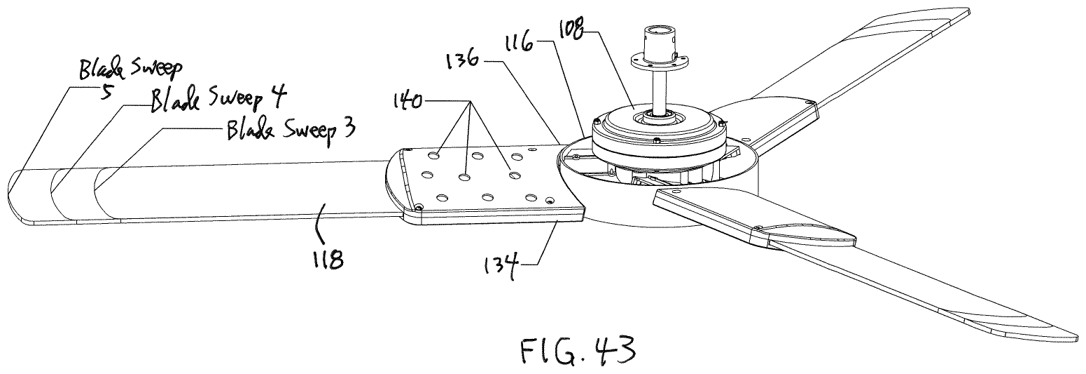

FIG. 35 is another bottom view of the interior of the blade support shell 116 showing fan blades 118 after being assembled or joined to the internal blade brackets 130. The blades 118 are attached to the internal blade brackets 130 along the inner-most radius row of attachment points 126 for the most-retracted position and smallest possible blade sweep diameter. In contrast, FIG. 36 shows the interior of the blade support 116, where the fan blades 118 are mounted to the outer-most row of attachment points 126. FIG. 36 also depicts the inner-most row of unused attachment points 126. When the fan blades 118 are mounted to the outer-most row of attachment points with the larger radius, the fan blade sweep is set at the largest sweep diameter possible. FIG. 42 illustrates the two diameters of fan blade sweeps achievable using the two rows of attachment points 126. Blade Sweep 1 corresponds to a smaller blade sweep and Blade Sweep 2 corresponds to a larger blade sweep.

In FIG. 34, there are only two rows of attachment points 126 on the blade brackets 130 set at two different radii as measured from the rotating center hub 132, but it is contemplated that there may be more than two rows to set the fan blades 118 at more than two blade sweep diameters. The proximal ends of the fan blades 118 are thus held in place by the slot 128 and the threaded fasteners screwed into the attachment points 126. Therefore, the internal blade mounting hardware for blade sweep adjustment is hidden from view inside the blade support shell, giving the fan a clean and minimalist appearance. Further, without blade irons or bolts that are exposed and passing through the air, there is reduced wind drag on the rotating fan blades leading to greater efficiency, and much less wind noise from air turbulence over bolt heads. This leads to quiet operation of the ceiling fan at any RPM.

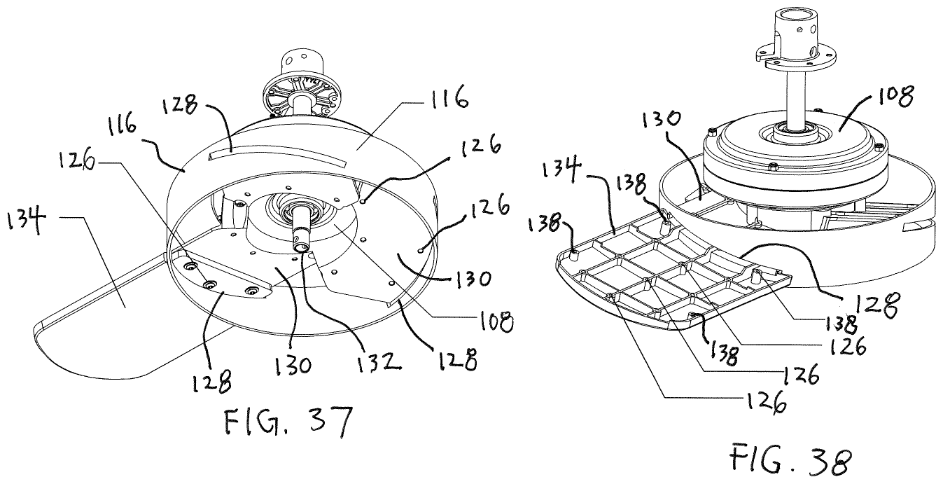

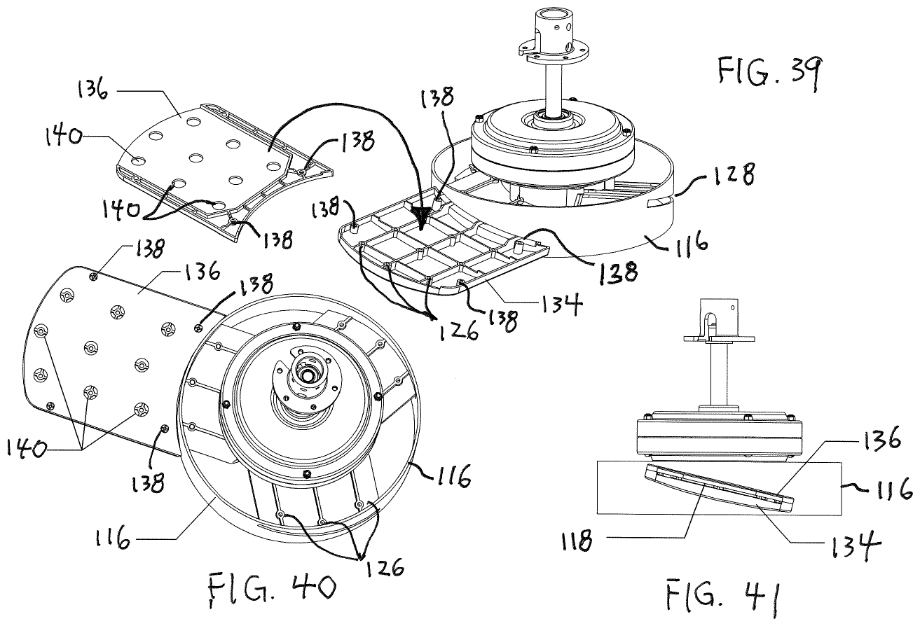

FIGS. 37-41, 43, and 44 is an alternative embodiment employing optional external blade brackets to further expand the range of blade sweeps achievable by the present invention. Specifically, FIG. 37 shows an external blade bracket bottom 134 attached to internal blade bracket 130 inside the blade support shell 116. The two parts are jointed at a row of the attachment points 126 of the internal blade bracket 130. FIG. 38 shows the top side of the external blade bracket bottom 134, where there are three more rows of attachment points 126 with each row spaced at a different radius as measured from the center hub 132. The external blade bracket bottom 134 extends through the corresponding slot 128 formed in the blade support shell 116.

FIG. 39 shows how the external blade bracket top 136 fits atop the external blade bracket bottom 134. The blade bracket top 136 has through-hole openings 140 that align and correspond with the three rows of attachment points 126 of the blade bracket bottom 134. FIG. 41 shows a fan blade 118 with its proximal end sandwiched between the blade bracket top 136 and blade bracket bottom 134. The slightly enlarged openings 140 expose the attachment points 126 for top easy access by the installer. Thus, the fan blade 118 is sandwiched between the top and bottom halves of the external blade brackets 136, 134. This is seen in FIGS. 41 and 43.

The fan blade 118 freely slides in or out of the external blade brackets 136, 134 allowing the user to select one of the three additional rows of attachment points 126 to set the blade sweep, all of which are visible through the enlarged openings 140. Once the blade sweep is selected, the user locks down via fasteners the fan blade 118 to the external blade bracket bottom 134 via the openings 140. The external blade bracket top 136 and bottom 134 are assembled and held together at mounting posts by fasteners 138, rivets, or the like (FIGS. 38-40). If the user has a desire to change the blade sweep, it is not necessary to disassemble the external blade bracket top from the bottom 136, 134, because the openings 140 allow topside access to the fasteners holding the fan blade 118 to the attachment points 126. The fasteners can be loosened or removed, then the fan blade 118 slid farther in or out of the still assembled external blade bracket halves 136, 134 to a different row of attachment points 126 for a different blade sweep. Therefore, the enlarged top access openings 140 for last-minute changes to fan blade sweep are a great convenience to the user when and after the fan is mounted to the ceiling. Further, the external blade brackets 136, 134 are aerodynamic, and hide all boltheads that are recessed underneath the surface to minimize drag and wind noise.

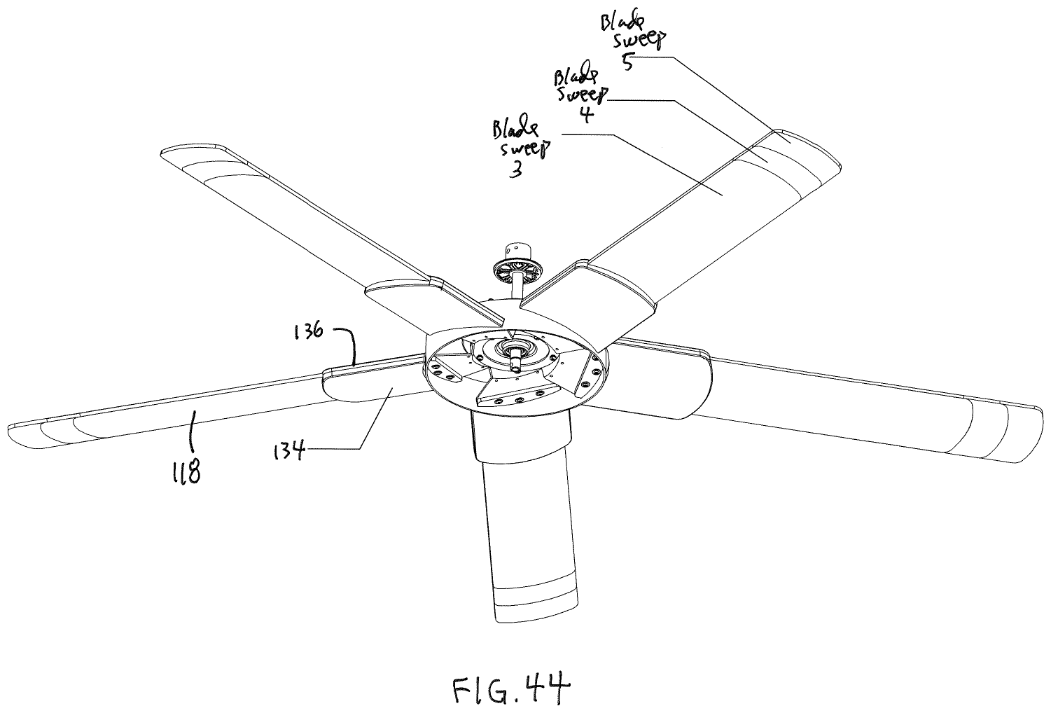

FIGS. 43 and 44 are top and bottom views of the external blade brackets 136, 134 being used to create Blade Sweep 3, Blade Sweep 4, and Blade Sweep 5. They illustrate the additional achievable blade sweep diameters. When this embodiment with external adjustment points is implemented in conjunction with the prior embodiment with internal attachment points, it is possible to have five different blade sweep diameters in a single fan kit using a single length set of fan blades. This is depicted in FIGS. 45a-45e.

While the particular forms of the invention have been illustrated and described, it will be apparent that various modifications can be made without departing from the spirit and scope of the invention. It is contemplated that elements from one embodiment may be combined or substituted with elements from another embodiment.

We claim:

1. An electric ceiling fan with a selectable blade sweep, comprising:
a down rod;
a canopy receiving the down rod;
a motor disposed proximate the canopy, wherein the motor drives a rotating hub;
a plurality of low profile, solid core, non-telescoping fan blades all of the same fixed length, and each fan blade having a proximal end and a distal end;
a blade support shell at least partially covering the rotating hub, having a plurality of slots to receive the proximal end of each fan blade;
an internal blade bracket including rows of attachment points disposed at radial locations that attach the proximal end of each fan blade for a selected blade sweep, wherein the internal blade bracket engages the rotating hub and is enclosed within the blade support shell;
an electronic motor controller receiving [a] an input signal from a first selectable switch that adjusts motor RPM, and [b] an input signal from a second selectable switch that adjusts the motor output to compensate for at least rotational inertia and air resistance from the selected blade sweep; and
a power supply conducting electricity to the motor and controller.

2. The electric ceiling fan of claim 1, wherein the electric ceiling fan further comprises an external blade bracket that engages the internal blade bracket, and the external blade bracket includes attachment points set at different radial distances and attach to the fan blade to set the blade sweep.

3. The electric ceiling fan of claim 1, further comprising a wireless remote in communication with the electronic motor controller and includes the first selectable switch and the second selectable switch.

4. The electric ceiling fan of claim 1, wherein the ceiling fan includes an LED light disposed thereon.

5. The electric ceiling fan of claim 1, wherein the attachment points are arranged in rows spaced apart at different radii.

6. The electric ceiling fan of claim 1, wherein the external blade bracket is formed from top and bottom halves, and the top half includes openings that expose attachment points disposed on the bottom half.

7. The electric ceiling fan of claim 1, wherein each of the plurality of fan blades includes a leading edge that has a thickness that is less than 10% of a chord of the blade.

8. The electric ceiling fan of claim 1, wherein each of the plurality of fan blades includes an aspect ratio of a leading-edge thickness to a chord of the blade that is greater than 1:10.

9. The electric ceiling fan of claim 1, wherein the ceiling fan further comprises a sensor disposed on the internal blade bracket for detecting rotational inertia and air resistance from the blade sweep with a feedback loop to the electronic motor controller.

10. An electric ceiling fan with a selectable blade sweep, comprising:
a down rod;
a canopy receiving the down rod;
a motor disposed proximate the canopy, wherein the motor drives a rotating hub;
a plurality of solid core, non-telescoping fan blades all of the same fixed length, wherein each fan blade includes a proximal end and a distal end;
a blade support shell, overlying the rotating hub, having a plurality of slots;
a selectable blade sweep adjustment means including at least one of:
an internal blade bracket including a plurality of attachment points disposed at different radial locations, wherein the internal blade bracket engages the rotating hub, and the internal blade bracket is entirely enclosed within the blade support shell;
an external blade bracket including a plurality of attachment points at different radial locations, wherein the external blade bracket is disposed externally to the blade support shell; and
wherein the proximal end of each fan blade engages at least one of the attachment points of the internal and external blade brackets to select the blade sweep;
an electronic motor controller receiving [a] an input signal from a first selectable switch that adjusts motor RPM, and [b] an input signal from a second selectable switch that modifies the motor output to compensate for at least rotational inertia and air resistance from the selected blade sweep; and
a power supply conducting electricity to the motor and the electronic motor controller.

11. The electric ceiling fan of claim 10, wherein the ceiling fan includes a wireless remote in communication with the electronic motor controller, and the wireless remote further includes the first selectable switch and the second selectable switch thereon.

12. The electric ceiling fan of claim 10, wherein the second selectable switch does not change the motor RPM.

13. The electric ceiling fan of claim 11, wherein the first selectable switch is exposed on an exterior of the wireless remote and the second selectable switch is enclosed.

14. The electric ceiling fan of claim 10, wherein the second selectable switch is disposed on the ceiling fan for on-board input to the electronic motor controller.

15. An electric ceiling fan with a selectable blade sweep, comprising:
a down rod;
a canopy receiving the down rod;
a motor disposed proximate the canopy, wherein the motor drives a rotating hub;
a plurality of solid core, non-telescoping fan blades all of the same fixed length, wherein each fan blade includes a proximal end and a distal end, and wherein each fan blade includes a thin, low profile, rectangular cross-sectional shape;
a blade support shell disposed over the rotating hub having a plurality of slots;
a user selectable blade sweep adjustment means including at least one of:
an internal blade bracket including a plurality of attachment points disposed at different radial locations, wherein the internal blade sweep bracket engages the rotating hub and is enclosed within the blade support shell;
an external blade bracket including a plurality of attachment points disposed at different radial locations, wherein the external blade bracket is disposed externally to the blade support shell; and
wherein the proximal end of each fan blade engages the plurality of attachment points of at least one of the internal blade bracket and external blade bracket to select the blade sweep;
an electronic motor controller receiving load input parameters from a first selector switch disposed remotely from the ceiling fan to adjust motor RPM, and a second selector switch disposed on the ceiling fan, that adjusts the motor to compensate for at least rotational inertia and air resistance caused by the blade sweep selection and does not change the motor RPM;
a power supply conducting electricity to the ceiling fan.

16. The electric ceiling fan of claim 15, wherein the electric ceiling fan further comprises a wireless remote in communication with the electronic motor controller, and the wireless remote includes the first and second selector switches.

17. The electric ceiling fan of claim 15, wherein the electric ceiling fan includes selectable blade sweeps of 44 in., 48 in., 52 in., 56 in., and 60 in.

18. The electric ceiling fan of claim 15, wherein the electric ceiling fan includes an LED light source.

19. The electric ceiling fan of claim 16, wherein the first selector switch is exposed on an exterior of the wireless remote and the second selector switch is hidden inside.

20. The electric ceiling fan of claim 15, wherein the ceiling fan further comprises a sensor detecting rotational inertia and air resistance from the blade sweep with a feedback loop to the electronic motor controller.
